(19) United States
(12) Patent Application Publication
(10) Pub. No.: US 2013/0025754 A1
(43) Pub. Date: Jan. 31, 2013

(54) ARMORED TIRE AND WHEEL ASSEMBLY

(71) Applicant: Jeff Kolb, St. Charles, MO (US)

(72) Inventor: Jeff Kolb, St. Charles, MO (US)

(21) Appl. No.: 13/550,590

(22) Filed: Jul. 16, 2012

Related U.S. Application Data
(63) Continuation of application No. 12/575,786, filed on Oct. 8, 2009, now abandoned.
(60) Provisional application No. 61/103,684, filed on Oct. 8, 2008.

(51) Int. Cl. B60C 19/00

(52) U.S. Cl. 152/187; 152/185

(57) ABSTRACT

An armored tire and wheel assembly includes a wheel; a tire mounted on the wheel; a first annular support rail disposed on one side of the tire, the first annular support rail comprising a plurality of rail elements each pivotally connected to the adjacent rail elements; and a second annular support rail disposed on the other side of the tire, the second annular support rail comprising a plurality of rail elements each pivotally connected to the adjacent rail elements. There are a plurality of pads or shoes, each pad extending across the surface of the tire and secured adjacent one end to a rail element of the first annular support rail and adjacent the other end to a rail element of the second annular support rail.

### CROSS-REFERENCE TO RELATED APPLICATIONS

This application is a continuation of U.S. patent application Ser. No. 12/575,786, filed Oct. 8, 2009, which claims priority to U.S. Provisional Patent Application No. 61,103,684, filed Oct. 8, 2008. The entire disclosures of each of the above applications are incorporated herein by reference.

### BACKGROUND

This invention relates to a tire and wheel assembly for construction and similar equipment, and in particular, to an armored tire and wheel assembly for use on such equipment.

Rubber tires offer a number of advantages, and are widely used on wheeled equipment, such as excavating and grading equipment. However, under some conditions, rubber tires wear quickly, resulting in substantial down time and cost as the rubber tires are replaced. Track equipment has limited lives, and limited service speeds. Similarly, protective chains for tires also have problems. They can be difficult to install and maintain, and they also limit the speed at which the vehicle can be operated.

Attempts have been made to provide armored tires for heavy equipment, see for example, U.S. Pat. Nos. 4,132,258 for Armored Tire; 4,043,609 for Armored Tire Having a Flexible Tapered Belt Arrangement; 4,013,112 for Anchor Plate Tire Having A Sub-Lug Equipped Anchor Plate; 4,010,789 for Anchor Plate Tire; 3,776,291 for Track-Over-Tire Driving Arrangement; 1,373,905 for Tractor Wheel; 3,500,944 for Convertible Wheeled And Tracked Vehicle; 4,480,670 for Track Belt Assembly; 4,328,849 for Vehicle Tire With Tractive Elements; 4,258,768 for Fastener Assembly; 3,899,220 for Flexible Sealed Track Belt; 872,096 for Means For Prevent Side Slip In Pneumatic Tires; 1,226,254 for Non-Skid Tire; 3,871,720 for Traction Tread Band; and 4,237,950 for Tracked Armored Tire Assembly Using A Two Pieced Grouser Retainer, the entire disclosures of which are incorporated herein by reference. However, these devices each suffered from a variety of disadvantages, such that none is in widespread use today.

### SUMMARY

Embodiments of the present invention provide an armored tire and wheel assembly for use on wheeled equipment, such as construction equipment. Generally, a preferred embodiment of the armored tire and wheel assembly comprises a wheel; a tire mounted on the wheel; a first annular support rail disposed on one side of the tire, the first annular support rail comprising a plurality of rail elements each pivotally connected to the adjacent rail elements; and a second annular support rail disposed on the other side of the tire, the second annular support rail comprising a plurality of rail elements each pivotally connected to the adjacent rail elements. There are a plurality of shoes or pads, each extending across the surface of the tire and secured adjacent one end to a rail element of the first annular support rail and adjacent the other end to a rail element of the second annular support rail.

In some preferred embodiments the tire has a plurality of recesses therein, and at least some of the shoes or pads are adapted to engage one of the recesses in the tire.

In another aspect, embodiments of the present invention provide an armored belt for the tires on a wheeled vehicle. The armored belt comprises a first annular support rail disposed on one side of the tire, the first annular support rail comprising a plurality of rail elements each pivotally connected to the adjacent rail elements; and a second annular support rail disposed on the other side of the tire, the second annular support trail comprising a plurality of rail elements each pivotally connected to the adjacent rail elements. There are a plurality of shoes or pads, each adapted to extend across the surface of the tire, secured adjacent one end to a rail element of the first annular support rail and adjacent the other end to a rail element of the second annular support rail.

### BRIEF DESCRIPTION OF THE DRAWINGS

FIG. 1 is a side elevation of a preferred embodiment of an armored tire and wheel assembly, in accordance with the principles of this invention;

FIG. 2 is a top plan view of the armored tire and wheel assembly in FIG. 1;

FIG. 3 is a vertical cross-sectional view of the armored tire and wheel assembly taken along the plane of line 3-3 in FIG. 2;

FIG. 4 is a side elevation view of the armor belt for the armored tire and wheel assembly;

FIG. 5 is a top plan view of six of the pivotally connected links that form each of the annular support rails;

FIG. 6 is a partial plan view of a section of the armor for the armored tire and wheel assembly;

FIG. 7A is a top plan view of a standard pad of the armor for the armored tire and wheel assembly;

FIG. 7B is a bottom plan view of the standard pad;

FIG. 7C is a side elevation view of the standard pad;

FIG. 7D is an end elevation view of the standard pad;

FIG. 8A is a top plan view of a tire-engaging pad of the armor for the armored tire and wheel assembly;

FIG. 8B is a bottom plan view of the tire-engaging pad;

FIG. 8C is a side elevation view of the tire-engaging pad;

FIG. 8D is an end elevation view of the tire-engaging pad;

FIG. 9A is a first side elevation view of the tire of the armored tire and wheel assembly;

FIG. 9B is an edge elevation of the tire;

FIG. 9C is a side elevation view of the tire, on the side opposite from that shown in FIG. 9A;

FIG. 10A is a side elevation view of the wheel;

FIG. 10B is top plan view of the wheel;

FIG. 10C is a vertical cross-sectional view taken along the plane of line 10C-10C in FIG. 10B; and

FIG. 10D is a vertical cross-sectional view similar to FIG. 10C, showing two hub centers.

Corresponding reference numerals indicate corresponding parts throughout the several views of the drawings.

### DETAILED DESCRIPTION

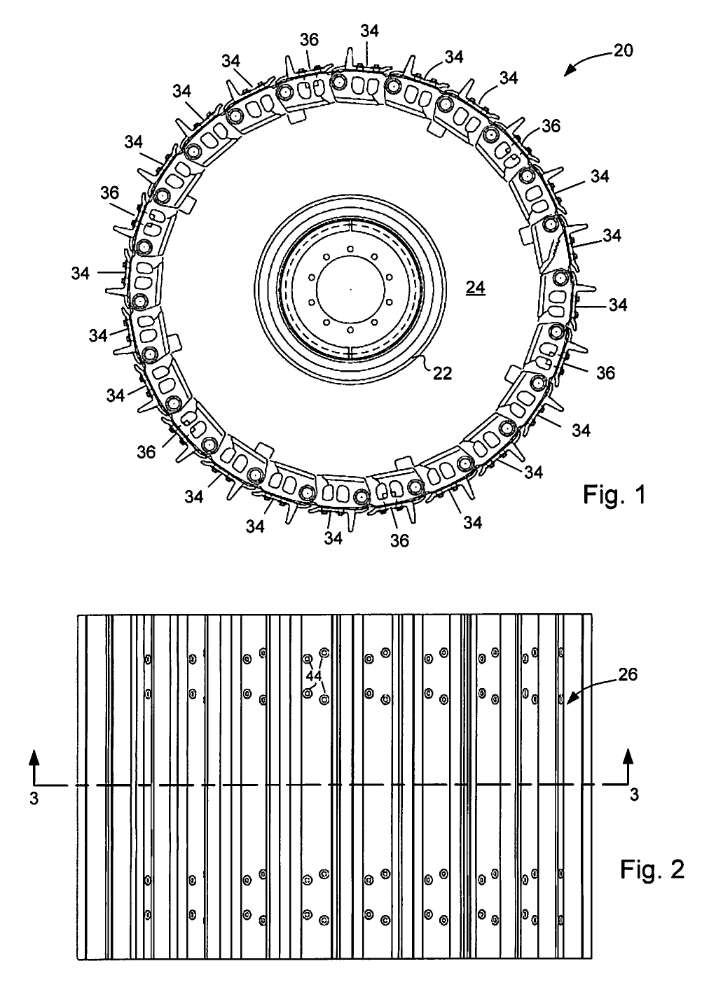

A preferred embodiment of an armored tire and wheel assembly constructed according to the principles of this invention is indicated generally as 20 in FIGS. 1 and 2. Generally, the assembly 20 comprises a wheel 22 having a tire 24 thereon. The tire 24 is preferably a pneumatic tire, but could be some other type of tire, such as a solid tire or foam-filled tire. An armored belt 26 is disposed over the tread and at least part of each of the sidewalls of the tire 24. The armored belt 26 comprises first and second annular support rails 28 and 30, connected by a track 32 comprising a plurality of pads or shoes 34, 36 extending between the first and second annular support rails.

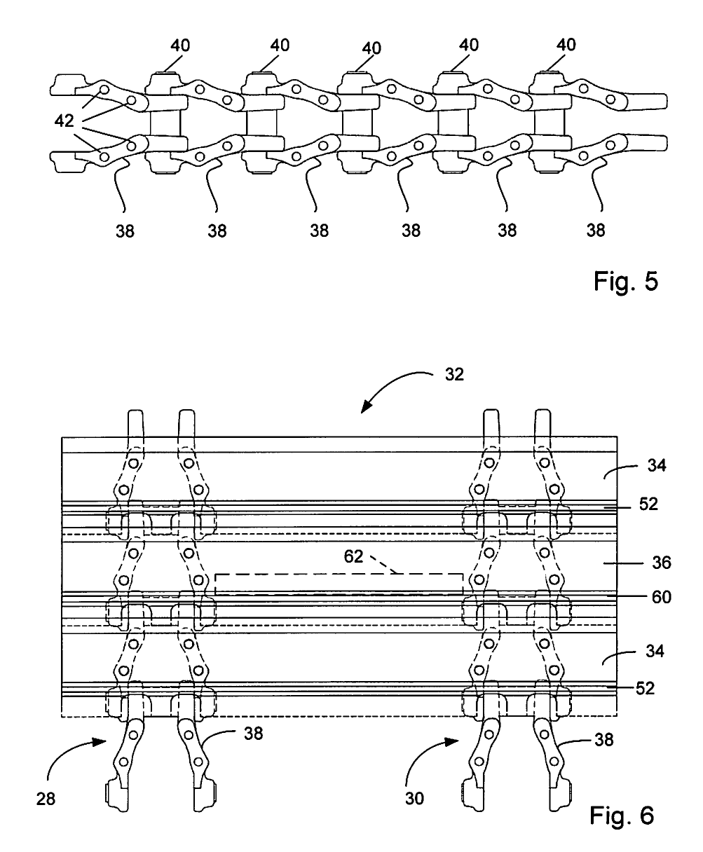

As best shown in FIGS. 5 and 6, each of the annular support rails 28 and 30 comprises a plurality of links 38, each pivotally joined to adjacent, similar links with pins 40. The pins can be solid, but are preferably hollow tubes to reduce weight and facilitate lubrication. The pivotally joined links 38 are joined together in a continuous chain to form each of the annular support rails 28 and 30. FIGS. 1 and 4, show 24 links 38 pivotally joined together to form one of the annular support rails 28 or 30, although fewer or more links could be used depending upon the size of the tire 24 in the wheel 20. The links 38 can be custom made, but are preferably conventional links used in conventional track drive equipment. Each of the links 38 has a plurality of mounting holes 42, which are positioned so that the holes are on the outer surface when the links are joined to form the rails 28 and 30.

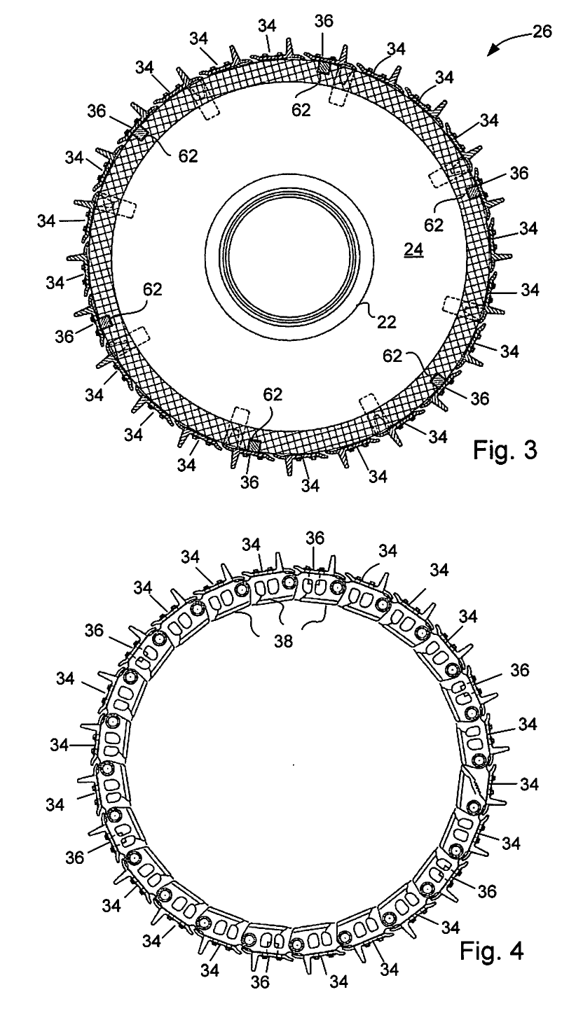

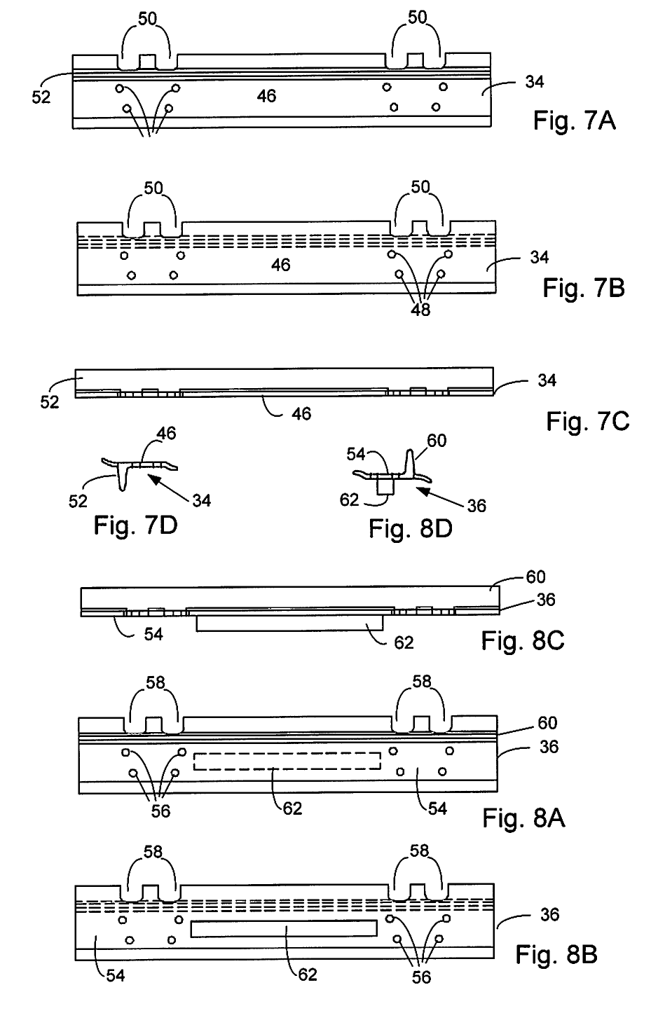

The track 32 comprises a plurality of pads or shoes 34, 36 mounted on, and extending between, the annular support rails 28 and 30. As shown best in FIG. 3, these pads include a plurality of standard pads 34 (shown in FIGS. 7A-7D) and a plurality of tire-engaging pads 36 (shown in FIGS. 8A-8D). Each of the pads 34, 36 is mounted on the mounting holes 42 on aligned links 38, in each of the first and second annular support rails 28, 30 with bolts 44.

As shown in FIGS. 7A-7D, the standard pad 34 comprises a generally flat panel section 46, having a plurality of mounting holes 48, and pairs of cutouts 50 for accommodating movement of links 38. An upwardly projecting grouser bar 52 extends across the flat panel section 46 of the pad 34. While one grouser bar 52 is shown in the Figures, the grouser bar could be omitted, or more than one grouser bar could be provided on the pads. As shown in FIGS. 8A-8D, the tire-engaging pad 36 is similar to the standard pad 34, comprising a generally flat panel section 54, having a plurality of mounting holes 56, and pairs of cutouts 58 for accommodating movement of the links 38. An upwardly projecting ridge 60 extends across the flat panel section 54 of the pad 36. However, unlike the standard pads 34, the tire-engaging pads 36 have a tire-engaging spline 62 for engaging a transverse groove on the tire 24, as shown best in FIG. 3. As show in the Figures, the majority of the pads are standard pads 34, but every fourth bar is a tire-engaging pad 36. Of course, the relative proportions and relative positions of the standards pads 34 and the tire-engaging pads 36 could be varied.

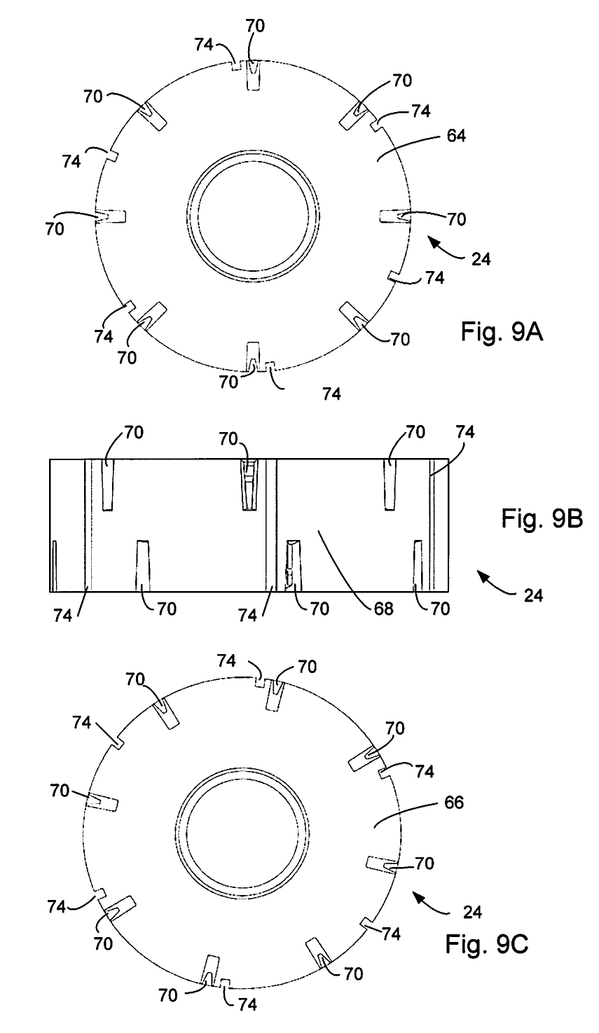

The tire 24 can be any heavy duty tire appropriate for the vehicle, but it is preferably adapted for use with the armor belt 26. As shown in FIGS. 9A-9C, the tire 24 has first and second sidewalls 64 and 66, connected by a tread 68. There are a plurality of elongate voids 70 forming lugs 72 on the surface of the tread 68. These elongate voids 70 facilitate cooling of the tires 24 when they are in service. There are also a plurality of transverse grooves 74 for receiving the splines 62 from the tire-engaging pads 36. The grooves 74 are spaced to accommodate the particular arrangement of splines 62 on the armor belt 26

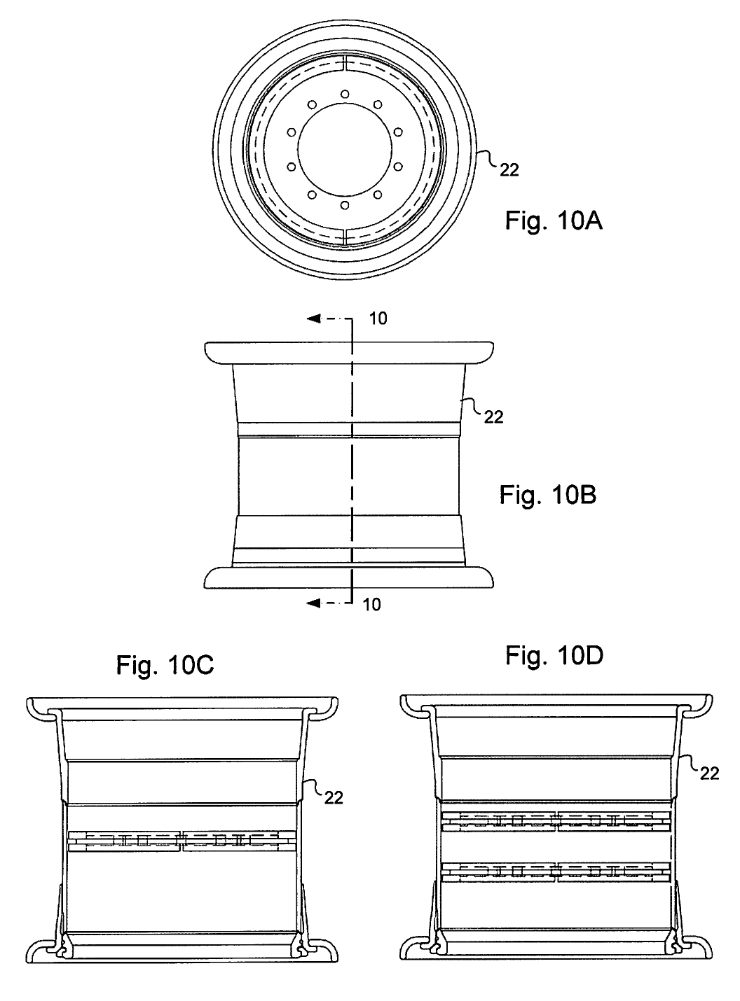

The wheel 22 is shown in FIGS. 10A-10D, and is preferably a conventional multi-part wheel for mounting tire 24. The wheel 22 can be either a single or multiple mount, having one or more hub centers as necessary, depending upon the size of the tire 24. With wider tires, it may be desirable to secure the wheel at two or more locations to reduce bending moments and torque on the mounting.

A preferred mounting of the wheel is shown in FIG. 11. As shown in FIG. 11, the structure for mounting the wheel 22 on the hub of a machine comprises a mounting ring 80 that is secured to the inside of the wheel, such as by welding.

### Operation

The armored tire and wheel assembly 20 is assembled by mounting the tire 24 on a wheel 22. The armored belt 26. is then installed over the tire by assembling the first and second annular support rails 28 and 30 adjacent either side wall of the tire 24, and connecting the links 38 of each of the annular support rails 28 and 30, with pads 34 and 36. The size of the belt 26, will of course, depend on the size of the tires required by the vehicle, and be anywhere from 24 inches to 72 inches or more. The size of the tire 24 may need to be adjusted to accommodate the size of the outside diameter of the annular support rails 28 and 30. This can be done by shaving the tread of the tire, building up the treat of the tire, and to some extent, controlling the inflation of the tire. In at least some embodiments, it is preferred that the diameter of the tire at the treat, match the inside diameter of the belt 26, to reduce or eliminate relative movement between the tread of the tire and the inside of the belt. The splines 62 are aligned with the grooves 74 so that the armored belt 26 turns with the tire 24 and wheel 22. The tire and wheel assembly 20 can operate like a conventional tire and wheel, but the armored belt 26 protects the tire 24 and extends its life. The assembly 20 can be used with any type of wheeled vehicle, including construction equipment, mining equipment, farming equipment, and military equipment. The assembly 20 can be made in any size to accommodate different types and sizes of equipment.

What is claimed is:

1. An armored wheel and tire assembly comprising:
a wheel;
a wheel mounted on the hub;
a first annular support rail disposed on one side of the tire, the first annular support rail comprising a plurality of rail elements each pivotally connected to the adjacent rail elements;
a second annular support rail disposed on the other side of the tire, the second annular support rail comprising a plurality of rail elements each pivotally connected to the adjacent rail; and
a plurality of pads, each pad extending across the surface of the tire and secured adjacent one end to a rail element of the first annular support rail and adjacent the other end to a rail element of the second annular support rail.

2. The wheel according to claim 1, wherein the tire has a plurality of recesses therein, and wherein at least some of the pads engage one of the recesses in the tire.

3. A shield for the tires on a construction vehicle, the shield comprising a first annular support rail disposed on one side of the tire, the first annular support rail comprising a plurality of rail elements each pivotally connected to the adjacent rail elements;
a second annular support rail disposed on the other side of the tire, the second annular support rail comprising a plurality of rail elements each pivotally connected to the adjacent rail elements; and
a plurality of pads, each pad extending across the surface of the tire and secured adjacent one end to a rail element of the first annular support rail and adjacent the other end to a rail element of the second annular support rail.

4. The shield according to claim 3, wherein the tire has a plurality of recesses therein, and wherein at least some of pads engage one of the recesses in the tire.
